(19) United States
(12) Patent Application Publication
(10) Pub. No.: US 2024/0286377 A1
(43) Pub. Date: Aug. 29, 2024

(54) COATING LAYER FOR VEHICLE TRIM ELEMENT, TRIM ELEMENT AND METHOD THEREOF

(71) Applicant: MATERI'ACT, Nanterre (FR)

(72) Inventor: Benjamin QUESNEL, VALENCIA (ES)

(21) Appl. No.: 18/584,240

(22) Filed: Feb. 22, 2024

(30) Foreign Application Priority Data
Feb. 23, 2023 (FR) 23 01661

(51) Int. Cl. B32B 5/02; B32B 5/24; B60R 13/02

(52) U.S. Cl. CPC B32B 5/022; B32B 5/24; B60R 13/02; B32B 2250/02; B32B 2262/02; B32B 2262/144; B32B 2375/00; B32B 2605/08

(57) ABSTRACT

A covering layer for a vehicle trim element, a trim element and a method thereof are provided. The covering layer for the vehicle trim element is visible from outside of the trim element. The covering layer comprises a main layer and a protective layer (24) extending over an outer surface of the main layer. The protective layer is polyurethane-based. The main layer comprises a fiber web comprising: between 40 and 80% by mass of natural fibers, at least 40% of said natural fibers having a length of between 35 and 150 mm; and between 20 and 60% by mass of synthetic fibers, at least 40% of said synthetic fibers having a length of between 30 and 100 mm.

### CROSS-REFERENCE TO RELATED APPLICATION

This application is a U.S. non-provisional application claiming the benefit of French Application No. 23 01661, filed on Feb. 23, 2023, which is incorporated herein by reference in its entirety.

### TECHNICAL FIELD

The present disclosure relates to a covering layer for a vehicle trim element, the covering layer being intended to be visible from the outside of the trim element and comprising a main layer and a protective layer extending over an outer surface of the main layer, the protective layer being based on polyurethane.

### BACKGROUND

The disclosure applies, for example, to a trim element forming a door panel, a center console, or dashboard covering of a vehicle or other types of trim elements.

Generally, such a trim element comprises a rigid support covered with a covering layer giving it a desired outward appearance.

In order to protect the environment, it is known to manufacture the trim elements with natural materials that are recyclable and/or derived from recycling. It is thus known to manufacture rigid supports made of composite material comprising natural fibers.

However, the use of such natural fibers for manufacturing covering layers is not entirely satisfactory. Indeed, such covering layers have too great a rigidity, which complicates the covering of supports having non-planar surfaces, and is capable of generating corrugations or other defects, such as an upholstered “orange peel” appearance. The aesthetic appearance obtained is thus not always satisfactory because of this upholstered appearance, but also due to the presence of other visible defects due, for example, to the presence of natural fiber residues.

One aim of the disclosure is to propose a covering layer for a trim element that is economical and environmentally friendly, while making it possible to obtain a satisfactory outward appearance.

### SUMMARY

A covering layer of the aforementioned type is provided, and the main layer of the covering layer comprises a fiber web comprising:
between 40 and 80% by mass of natural fibers, at least 40% of said natural fibers having a length of between 35 mm and 150 mm, and
between 20 and 60% by mass of synthetic fibers, at least 40% of said synthetic fibers having a length of between 30 mm and 100 mm.

The mixture of natural fibers and synthetic fibers according to the disclosure thus makes it possible to form a covering layer that is flexible enough to cover rigid supports that can have curved surfaces. The presence of ripples, folds, or other defects is thus reduced, improving the outward appearance of the trim element. The use of natural fibers in the covering layer offers both an economic advantage and an ecological advantage.

The covering layer according to the disclosure may comprise one or more of the following features, taken alone or according to any technically conceivable combination:
the main layer is a non-woven obtained by hydroentangling the natural and synthetic fibers;
the natural fibers are selected from hemp and flax fibers, and mixtures thereof;
the natural fibers have a mass content of residues of less than 10%;
the synthetic fibers are selected from cellulose-based fibers, polypropylene fibers, polyethylene terephthalate fibers, and mixtures thereof;
the main layer has a basis weight of between 70 and 250 g/m², preferably substantially equal to 120 g/m².
the protective layer comprises at least one expanded sublayer having a thickness of between 0.20 mm and 0.55 mm, preferably substantially equal to 0.35 mm.

The disclosure also relates to a vehicle trim element, comprising a rigid support and a covering layer of the aforementioned type, the covering layer covering at least a part of the rigid support.

The disclosure further relates to a method for manufacturing a covering layer of the aforementioned type, comprising the following steps:
providing natural fibers;
providing synthetic fibers;
mixing the natural fibers and the synthetic fibers and forming the fiber web; and
covering the fiber web with the polyurethane-based protective layer.

According to a particular embodiment, the step of providing natural fibers comprises a prior step of refinement and defibrillation of the natural fibers so as to obtain a natural fiber composition having a mass content of residues of less than 10%.

### DESCRIPTION OF THE DRAWINGS

The disclosure will be better understood on reading the following description, given solely by way of example, and referring to the appended FIGURE, wherein:

FIG. 1 is a schematic view of a trim element according to the disclosure.

### DETAILED DESCRIPTION

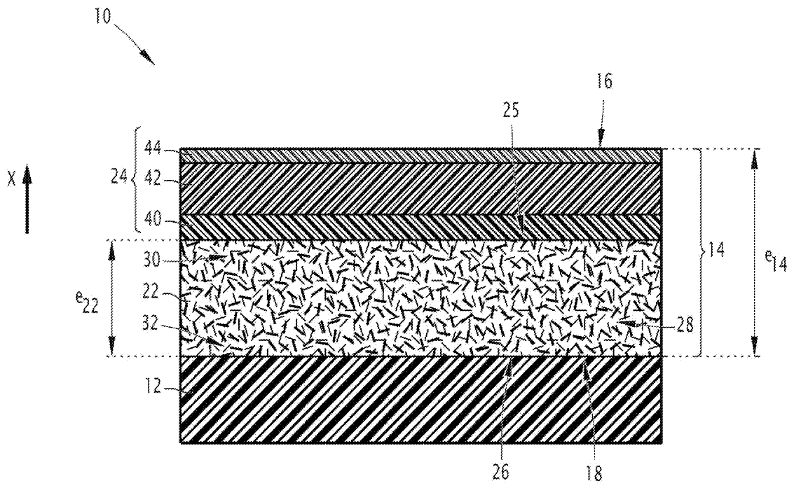

FIG. 1 shows a vehicle trim element 10, in particular a motor vehicle trim element. This representation is schematic and the proportions are not to scale.

The trim element 10 is, for example, a door panel, a center console or a dashboard cover of a vehicle or the like.

The trim element 10 comprises at least one covering layer 14. According to one embodiment that will now be described, the trim element 10 further comprises a rigid support 12.

The rigid support 12 makes it possible to give its shape to the trim element 10 and also give it some of its mechanical properties, in particular its rigidity. Thus, the rigid support 12 has, for example, a three-dimensional shape.

The rigid support 12 is made of a substantially rigid material, such as a plastic or a composite material. Therefore, the rigid support 12 has a stable shape that is substantially non-deformable under normal conditions of use, that is, when stresses that are normal during the use of a vehicle are applied to the support.

For example, the rigid support 12 is made of a thermoplastic material such as, for example, an olefinic plastic material or a thermoplastic acrylonitrile butadiene styrene polymer.

As a variant, the rigid support 12 is made of composite material and more particularly of composite material comprising natural fibers. The natural fibers are, for example, selected from flax, hemp, kenaf, coconut, sisal, henequen, jute and/or wood.

In the example of FIG. 1, the rigid support 12 is substantially planar in shape. Alternatively, the rigid support 12 has at least one curved surface intended to be covered by the covering layer 14.

The covering layer 14 covers at least part of the rigid support 12, advantageously the entirety of the rigid support 12. Preferably, the covering layer 14 covers the surfaces of the rigid support 12 that are visible once the trim element 10 is installed in the vehicle.

The covering layer 14 is made of a flexible material preferably having greater flexibility than the rigid support 12.

The covering layer 14 is preferably able to be elastically deformed under normal conditions of use, for example when a user presses on it.

Advantageously, the covering layer 14 matches the shape of the rigid support 12. For example, the covering layer 14 is bonded, stapled or attached with Velcro-type self-gripping fasteners on the rigid support 12.

The covering layer 14 comprises an exterior surface 16 forming the exterior surface of the trim element 10 visible from the passenger compartment of the vehicle and an interior surface 18 attached to the rigid support 12, for example by gluing or stapling.

Preferably, the covering layer 14 has a thickness e14 measured along a direction X separating the interior surface 18 from the exterior surface 16 of between 0.5 mm and 5 mm.

The covering layer 14 makes it possible to impart its appearance to the trim element 10.

The covering layer 14 comprises a main layer 22, preferentially intended to be visible from the outside of the trim element 10, and a protective layer 24 intended to cover the main layer 22.

The main layer 22 has an outer surface 25 and an inner surface 26, said inner surface 26 corresponding to the interior surface 18 of the covering layer 14.

The main layer 22 comprises at least one fiber web 28.

Optionally, the main layer 22 further comprises pigments and/or additives. The pigments make it possible to color the main layer 22 in a desired color and to improve the appearance thereof. The additives, for example, make it possible to increase the resistance to UV, chemicals, abrasion and/or moisture.

The fiber web 28 comprises between 40% and 80% by mass of natural fibers 30 and between 20% and 60% by mass of synthetic fibers 32. Preferably, the fiber web 28 comprises 50% by mass of natural fibers 30 and 50% by mass of synthetic fibers 32.

Advantageously, the fiber web 28 is devoid of a binder, in particular resin, for example polyurethane resin, acrylic resin and polyolefin resin, or latex.

The natural fibers 30 are, for example, selected from flax, hemp, cotton, kenaf, coconut, sisal, henequen, jute, cellulose-based fibers and mixtures thereof. Preferably, the natural fibers 30 are chosen from flax fibers, hemp fibers and a mixture of the two.

Preferably, the natural fibers 30 comprised in the main layer 22 have an average length greater than 35 mm, preferably between 40 mm and 100 mm. Their titer is advantageously between 2 dtex and 50 dtex.

At least 40% of said natural fibers 30 have a length of between 35 mm and 150 mm, preferably between 40 mm and 100 mm.

Preferably, less than 60% of said natural fibers 30 have a length of less than 35 mm. Advantageously, less than 20% of said natural fibers 30 have a length of less than 9 mm.

Preferably, the natural fibers 30 are derived from rod plants having undergone a refining step and a defibrillation step. During the plant defibrillation step, the natural fibers 30 are separated from residues (called “shives” or sometimes “hurds”) coming from the rod.

In the sense of the application, the residues are the residues derived from the stem of a plant and different from the natural fibers. When the plant is hemp, these residues include, or consist of, the shives. When the plant is flax, these residues include, or consist of, the hurd. Said residues do not have the same properties (in particular the same properties as reinforcing filler, even mechanical properties, etc.) as natural fibers.

Typically, the residues have a thickness greater than 100 μm, in particular greater than 300 μm.

Advantageously, the fiber web 28 comprises less than 30% by mass of residues. Preferably, the fiber web 28 comprises less than 5% by mass of residues having a thickness greater than 200 μm, and less than 1% by mass of residues having a thickness of greater than 400 μm.

The synthetic fibers 32 are chosen from synthetic fibers of natural origin, for example regenerated cellulose fibers, in particular viscose, cupro and/or modal fibers, alginate viscose fibers, lyocell fibers, PLA (polylactic acid) fibers, and mixtures thereof.

Alternatively or additionally, the synthetic fibers 32 are formed from petroleum derivatives or molecules resulting from green chemistry (for example ethylene from bio-ethanol). The synthetic fibers 32 are, for example, chosen from polyolefin fibers such as fibers of polyethylene or/and polypropylene, polyester, polyamide, polyimide, polyethylene terephthalate (PET) and mixtures thereof.

Preferably, the synthetic fibers 32 are chosen from cellulose fibers, alginate viscose fibers, lyocell fibers, PLA fibers, polyethylene terephthalate fibers, polypropylene fibers, and mixtures thereof.

Advantageously, the synthetic fibers 32 are recycled fibers.

Preferably, the synthetic fibers 32 comprised in the main layer 22 have an average length of between 30 mm and 100 mm. Their titer is advantageously between 1.7 dtex and 4 dtex.

Advantageously, at least 40% of said synthetic fibers have a length of between 30 and 100 mm. Preferably, at least 60% of said synthetic fibers have a length of between 30 and 100 mm, advantageously between 40 and 80 mm.

Advantageously, the synthetic fibers 32 are pre-crossed and coated with a protective layer based on polyurethane or polyvinyl chloride.

In the embodiment of FIG. 1, the main layer 22 is a nonwoven. Said nonwoven is preferably obtained by a hydroentangling (also called “spunlace”) process. Natural 30 and synthetic 32 fibers are entangled using high-pressure water jets according to a method that will be described later.

Preferably, the main layer 22 has a basis weight of between 70 and 250 g/m², preferably substantially equal to 120 g/m². The main layer 22 advantageously has a low variation in its basis weight, preferably less than 15%.

Preferably, the after-entanglement fiber web 28 is compressed, for example by lamination, in order to form the main layer 22.

The resulting main layer 22 thus has a smooth and homogeneous appearance.

The main layer 22 advantageously has a thickness e22 of between 0.05 mm and 2 mm, the thickness e22 being measured along the direction X between the outer surface 25 and the inner surface 26 of the main layer 22.

The protective layer 24 extends over the outer surface 25 of the main layer 22. Preferably, the protective layer 24 covers at least 90%, advantageously, all of the outer surface 25 of the main layer 22.

The function of the protective layer 24 is to protect the main layer 22, in particular against ultraviolet radiation that can cause accelerated aging of the main layer 22, and/or against friction, due for example, to the passengers of the vehicle, and which are likely to form scratches.

The protective layer 24 is advantageously transparent or translucent, so that the main layer 22 is advantageously visible from the outside of the trim element 10.

The protective layer 24 is based on polyurethane and preferably comprises at least one expanded sublayer 42.

In the embodiment shown in FIG. 1, the protective layer 24 comprises three sublayers 40, 42, 44.

A first sublayer 40 is directly in contact with the main layer 22 and forms an adhesive layer ensuring the good adhesion of the protective layer 24 to the main layer 22. The first sublayer 40 preferably has a thickness of between 0.05 and 0.10 mm, typically, substantially equal to 0.08 mm. The first sublayer 40 preferably has a basis weight of between 50 and 200 g/m². The first sublayer 40 is, for example, made from polyurethane, preferably from a solid base or aqueous base solvent, advantageously biosourced, or from polyvinyl chloride.

The second sublayer 42, also called expanded sublayer 42, is arranged on the first sublayer 40. Preferably, the expanded sublayer 42 comprises a chemical blowing agent, for example azodicarbonamide (ADC). Alternatively, the expanded sublayer 42 comprises a physical blowing agent which generates a gas, for example carbon dioxide.

The second sublayer 42 preferably has a basis weight of between 230 and 280 g/m².

The second sublayer 42 preferably has a thickness of between 0.20 and 0.55 mm, typically substantially equal to 0.35 mm.

The third sublayer 44 is arranged on the second sublayer 42. When the protective layer 24 comprises only three sublayers 40, 42, 44, the third sublayer 44 forms the exterior surface 16 of the covering layer 14. The third sublayer 44 preferably has a thickness of between 0.01 and 0.05 mm, typically, substantially equal to 0.03 mm. The third sublayer 44 preferably has a basis weight of between 5 and 35 g/m². The third sublayer 44 is for example made from aqueous-based polyurethane or polyvinyl chloride.

The protective layer 24 is obtained by application to the exterior surface of the main layer 22 of a composition or several polyurethane-based compositions.

According to a variant not shown, the protective layer 24 further comprises a fourth sublayer, called the superficial layer, covering the third sublayer 44 and forming the exterior surface 16 of the covering layer 14. Preferably, said fourth sublayer has a mass per unit area of between 5 and 600 g/m². The fourth sublayer is, for example, made from aqueous-based polyurethane or polyvinyl chloride.

The protective layer 24 preferably has a tensile strength greater than 200 kPa and a compression stress, defined according to standard ISO 3386-1 (Oct. 1, 2015 version), of between 10 KJ/kg and 40 KJ/kg.

The covering layer 14 has the advantage of being flexible and being able to cover a rigid support 12 optionally having curved shapes, while comprising a high natural fiber content. The appearance of the covering layer 14 is therefore not degraded during the step of application onto the rigid support 12.

The trim element 10 thus manufactured is economical and environmentally friendly, while having a satisfactory outward appearance, the covering layer 14 according to the disclosure limits the presence of defects in the main layer 22 or at the protective layer 24. In particular, the presence of folds or other asperities typically greater than 0.18 mm, and therefore visible, is reduced. The aesthetic appearance of the trim element 10 is thus improved.

A method for producing such a trim element 10 will now be described.

First, the rigid support 12 is manufactured from thermoplastic material or from composite material. For example, the rigid support 12 is obtained by injection molding or by compression molding, in particular by thermocompression.

Then, the covering layer 14 is manufactured according to the method below.

A natural fiber composition 30 and a synthetic fiber composition 32 are provided.

Preferably, the step of providing natural fibers 30 comprises a prior step of refinement and defibrillation of the natural fibers so as to obtain a natural fiber composition having a mass content of residues of less than 10%.

Preferably, the step of providing synthetic fibers 32 comprises a prior step of coating synthetic fibers 32, for example by a polyurethane-based layer.

Then, the natural fibers 30 and the synthetic fibers 32 are mixed to form a fiber web forming the main layer 22.

According to a particular embodiment, the natural 30 and synthetic 32 fibers are entangled using high-pressure water jets according to a hydroentangling (also called “spunlace”) process.

The fibers 30, 32 are deposited as a dispersion on a canvas of a manufacturing machine to obtain a fibrous-based web material, and then the fibrous-based web is subjected to a series of jets of entanglement fluid, and dried to obtain a nonwoven.

For example, the web is subjected to a series of water jets, typically seven jets, and at a pressure of between 20 and 110 bar.

Advantageously, the energy applied to the web is between 2 and 30 KJ/kg, preferably substantially equal to 15 KJ/kg.

Preferably, the after-entanglement fiber web 28 is compressed, for example by lamination, in order to optimize the main layer 22.

In this particular embodiment, the main layer 22 obtained is a nonwoven. The hydroentangling process is particularly advantageous for reducing the presence of surface defects on the nonwoven.

The use of natural fibers 30 of homogeneous length and advantageously having undergone refining and defibrillation steps also makes it possible to reduce the presence of defects on the surface of the nonwoven.

The main layer 22 thus has a homogeneous appearance and a small variation in its basis weight, advantageously less than 15%.

Then, the protective layer 24 is applied to the outer surface 25 of the main layer 22.

The fiber web 28 is successively covered by several polyurethane-based compositions, having different solids contents, in order to form the various sublayers 40, 42, 44.

Said compositions are applied for example by spraying, roll coating or doctor blade coating.

Alternatively, the protective layer 24 is formed separately before being applied to the fiber web 28, for example by lamination.

Finally, the covering layer 14 is applied to the rigid support 12, for example manually, so as to cover at least part of the rigid support 12, advantageously the entire rigid support 12.

For example, the covering layer 14 is bonded, stapled or attached with self-gripping fasteners on the rigid support 12. Advantageously, the covering layer is applied manually to the rigid support, in particular if the rigid support 12 has a curved surface.

The trim element 10 is thus easy to manufacture and has a satisfactory aesthetic appearance, while being environmentally friendly thanks to the use of natural fibers 30.

According to one embodiment not shown, the main layer 22 is a woven fabric. Said woven is obtained by weaving natural 30 and synthetic 32 fibers, to form the fiber web 28.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A covering layer for a vehicle trim element, the covering layer being visible from outside of the vehicle trim element and comprising:
a main layer; and
a protective layer extending over an outer surface of the main layer, the protective layer being polyurethane-based;
wherein the main layer comprises a fiber web comprising:
between 40 and 80% by mass of natural fibers, at least 40% of said natural fibers having a length of between 35 mm and 150 mm; and
between 20 and 60% by mass of synthetic fibers, at least 40% of said synthetic fibers having a length of between 30 mm and 100 mm.

2. The covering layer according to claim 1, wherein the main layer is a nonwoven obtained by hydro-entanglement of the natural fibers and the synthetic fibers.

3. The covering layer according to claim 1, wherein the natural fibers are selected from hemp and flax fibers, and mixtures thereof.

4. The covering layer according to claim 1, wherein the natural fibers have a mass content of residues of less than 10%.

5. The covering layer according to claim 1, wherein the synthetic fibers are selected from cellulose-based fibers, alginate viscose fibers, lyocell fibers, polylactic acid fibers, polypropylene fibers, polyethylene terephthalate fibers, and mixtures thereof.

6. The covering layer according to claim 1, wherein the main layer has a basis weight of between 70 and 250 g/m².

7. The covering layer according to claim 6, wherein the main layer has a basis weight substantially equal to 120 g/m².

8. The covering layer according to claim 1, wherein the protective layer comprises at least one expanded sublayer having a thickness of between 0.20 mm and 0.55 mm.

9. The covering layer according to claim 1, wherein the protective layer comprises at least one expanded sublayer having a thickness substantially equal to 0.35 mm.

10. A vehicle trim element, comprising a rigid support and a covering layer according to claim 1, the covering layer covering at least a part of the rigid support.

11. A method for producing a covering element according to claim 1, said method comprising the following steps:
providing natural fibers;
providing synthetic fibers;
mixing the natural fibers and the synthetic fibers and forming the fiber web; and
covering the fiber web with the protective layer that is polyurethane-based.

12. The method according to claim 11, wherein the step of providing natural fibers comprises a prior step of refinement and defibrillation of the natural fibers so as to obtain a natural fiber composition having a mass content of residues of less than 10%.
